(19) United States
(12) Patent Application Publication
(10) Pub. No.: US 2004/0117301 A1
(43) Pub. Date: Jun. 17, 2004

(54) Information processing system, information processing method, and recording medium for an information processing program

(76) Inventors: Teruhiko Fujisawa, Shiojiri-shi (JP); Michiko Mizuno, Nagano-ken (JP); Satoshi Kinoshita, Matsumoto-shi (JP)

Correspondence Address: LIEBERSTEIN, EUGENE, WYATT, GERBER, MELLER, & O ROURKE, L.L.P., 99 PARK AVENUE, NEW YORK, NY, 10016, US

(21) Appl. No.: 10/678,407

(22) Filed: Oct. 3, 2003

(30) Foreign Application Priority Data
Oct. 4, 2002 (JP) 2002-292369

(51) Int. Cl. G06F 17/60

(52) U.S. Cl. 705/39

(57) ABSTRACT

A data processing system to manage credit card use for a plural number of credit cards and to reconcile credit card statements. The data processing system 1 has multiple POS terminals 21 and cash registers 25, and a personal computer 45. The POS terminals 21 and cash registers 25 can write card usage information to a small, portable storage device represented by an IC card 10 having a rewritable nonvolatile storage unit for storing multiple card usage information records. The card usage information includes credit card number information, payment method information, payment date information, and payment amount information. The personal computer 45 runs a read process to read the card usage information from the IC card 10, and a transaction management process based on the card usage information read by the read process. The IC card 10 can communicate wirelessly with the POS terminals 21 and cash registers 25.

### BACKGROUND OF THE INVENTION

1. Field of the Invention

The present invention relates to an information processing system and an information processing method for processing information relating to purchases made with a credit card, and to a recording medium for storing an information processing program implementing the steps of the information processing method.

2. Description of Related Art

Credit cards are often used to pay for purchases. To use a credit card, the user must first sign a credit card user agreement with the company issuing the credit card (the “card company” below), after which the credit card is issued. When a credit card is issued the name, address, age, occupation, and other personal information about the credit card holder (the “cardholder”) is registered in a database linked to the specific credit card number issued to that user. A bank account from which credit card balances are automatically debited may also be registered. The credit card number is also stamped into the surface of the issued credit card, and a number enabling the credit card number to be machine read is also recorded in a magnetic stripe affixed to the back of the credit card.

When using the credit card to purchase goods, the credit card holder typically hands the credit card to the checkout clerk after the total purchase amount is determined. The credit card number is then read from the magnetic stripe on the card by a card reader connected to a POS terminal, cash register, or credit authorization terminal (CAT) in the store, and a charge against the credit card number is processed for the purchase amount. More specifically, the CAT generates transaction advice containing payment date and time information, the credit card number, payment amount information, payment method information indicating the cardholder's selected payment method (single payment, multiple payments, revolving credit payments, deferred payment), and merchant identification code identifying the store where the card was used. The CAT then sends this transaction data over the public telephone network, for example, to the card company's server. Based on the received transaction advice, the card company server generates and stores transaction data. This transaction data includes a reference number uniquely identifying each transaction so that when (the payment date and time) how much (the payment amount) was charged to what card number can be easily tracked and retrieved.

When this transaction advice data is sent to the card company, the CAT also issues a printed receipt containing the transaction content (the purchased products, quantity, price, and total amount paid), a printed merchant copy including the total amount charged to the card, and a cardholder receipt that is a copy of the merchant copy of the total transaction. Payment by credit card is completed when the cardholder signs the merchant copy.

One result of using a credit card to pay for store purchases is that numerous transaction records are stored in the card company server for each credit card (specifically each credit card number), and the cardholder collects numerous credit card receipts (specifically one for each transaction).

When the predetermined closing date arrives, the card company server tallies the transaction total for that month for each credit card based on the transaction data stored in the server, and mails a printed statement containing the total balance due for that month and the payment date to the cardholder. This statement could, for example, be a record of all account activity that month and a payment coupon, or a statement of account activity and a report of the amount to be debited to the bank account registered for settling the credit card bill on a predetermined date.

Upon receiving this statement, the cardholder can then confirm if the transactions and balance due reported by the card company are correct by comparing the statement with the credit card receipts received with each purchase. This reconciliation process typically involves, for example, using a calculator to manually total the individual payment amounts from the credit card receipts, and comparing this total with the total reported by the card company. If the totals match and the total is to be debited from the cardholder's bank account, the cardholder then confirms that the account balance will be enough to cover the balance due on the preset payment date. If there will be insufficient funds, the cardholder must deposit the deficiency by the payment date. This assures that the balance due can be debited from the designated settlement account and transferred to the card company on the due date. This completes the cardholder's payment of all charges and purchases made using the credit card.

Japanese Patent Laid-Open Publication (kokai) 2001-84293 teaches a product purchase information management system (referred to below as the management system) having a product management terminal 3 and an accounting ledger generator 4. The product management terminal 3 writes product purchase information to a payment card 1 configured for recording such product purchase information 13 as the product name (the name of the product being purchased) and price (payment amount). The accounting ledger generator 4 reads the product purchase information recorded to the payment card, and generates account totals data 43 based on this product purchase information.

The payment card used in this management system could be an IC card, magnetic stripe card, or a barcode card, and is carried by the consumer 2, i.e., the owner (user) of the accounting ledger generator 4.

The product management terminal 3 has a register 30 connected to a card writer 32 for recording the product purchase information to the payment card, and a barcode reader 31, and is located on the merchant side (A1; a retail store, for example) of the transaction. This register also stores a product database 33 storing product data 12 such as the name and price of each product.

The accounting ledger generator is located on the consumer side of the transaction (A2; such as in the consumer's home), and includes a card reader 41 for reading the product purchase information from the payment card, a ledger data processor 42 for generating account ledger totals data based on the product purchase information read by the card reader, and a ledger totals data display 44 for displaying information based on the ledger totals data from the data processor 42.

When a consumer (user) purchases a product 10 using this management system, both the products to be purchased and the payment card are handed to the checkout clerk. The clerk then scans the barcodes from the product labels using a barcode reader. The register thus detects (identifies) the product code 11 from the scanned barcode, and reads the product data for the product corresponding to the product code from the product database. The register then generates the product purchase information based on the product data read from the product database, and records this product purchase information to the payment card by means of the card writer. The payment card thus stores product purchase information for the purchased goods.

The consumer receives the purchased merchandise and the payment card now storing the product purchase information, and returns home. To generate the ledger totals data based on the product purchase information recorded in the payment card, the user inserts the payment card to the card reader of the accounting ledger generator so that the card reader reads the product purchase information from the payment card. The ledger data processor then runs an account ledger generating process to generate the ledger totals data based on the payment data from the product purchase information. The ledger totals data is thus transferred to and stored in the budget ledger generator based on the product purchase information written to the payment card. The user can then display information based on this ledger data on the display unit for processing. See Japanese Patent Laid-Open Publication (kokai) 2001-84293, pp. 3 and 4.

Conventional methods of using credit cards present the following problems.

Specifically, a credit card receipt printed by the store with the total purchase amount is conventionally issued when a credit card is used to pay for a purchase at a retail store. The cardholder can then manage credit card use based on the information printed to the credit card receipt.

Because the credit card receipts are needed for comparison with the monthly credit card bill or debit notice mailed to the user by the card company, the credit card receipts must be kept at least until transactions on the credit card statement are confirmed. Because a credit card receipt is issued each time the card is used and the cardholder may accumulate numerous receipts during a normal billing cycle, storing and managing these many receipts becomes complicated and burdensome for the cardholder.

Another problem is that reconciling the credit card receipts with the credit card statement (debit notice or bill) typically requires manually totalling the purchase amounts printed to each credit card receipt. This makes the reconciliation process extremely complicated and burdensome for the user.

This reconciliation problem is worsened when a single user has multiple credit cards. In this case the user must separate the numerous credit card receipts by credit card, reconcile the receipts separately according to the payment due date for each card, and make sure there are sufficient funds in the bank to cover the credit card payments on the due date for each card whether the balance is paid by direct debit or other means. This is a significant burden on the cardholder.

As also noted above, a credit card receipt and cash register receipt are both issued when a purchase is made with a credit card. Because one receipt is issued for each purchase, multiple receipts may be received on the same day for purchases made at a single store during a single shopping excursion, such as when shopping at a department store and making purchases in multiple departments. Receiving and carrying multiple sales receipts in addition to the credit card receipts imposes yet another burden on the user that needs improving.

The management system taught in Kokai 2001-84293 cited above records the product purchase information to a payment card at the point of sale in lieu of printing a paper receipt for each purchase. The user therefore does not need to carry numerous receipts, and can generate data for a budget ledger relatively easily based on the product purchase information written to the payment card. A problem with this management system, however, is that while product name and price information can be identified for products paid for by credit card based on the product purchase information, information about which credit card (credit card number) was used for a particular purchase and when payment for that credit card purchase is due is not included in the product purchase information. The user must therefore retain the paper credit card receipts and reconcile the credit card receipts with the credit card bill. This management system therefore does nothing to alleviate this reconciliation problem for the user.

### SUMMARY OF THE INVENTION

The present invention is therefore directed to solving the above problems by providing a data processing system and method that reduce the burden on the user of credit cards and checks.

To achieve this object a data processing system according to the present invention has a portable storage device comprising a rewritable nonvolatile memory unit for storing card usage information for one or more credit cards used to make purchases; a first data processing device for running a write process for generating card usage information for a payment made with a credit card when a credit card is used to make a purchase, and writing the card usage information to the portable storage device; and a second data processing device comprising a processor for running a read process to read card usage information for each credit card written to the portable storage device, and a transaction management process based on the card usage information read by the read process.

The card usage information preferably includes the payment amount, i.e., the amount charged to the credit card, and credit card number for the credit card used to make a purchase. The processor of the second data processing device in this case executes as the transaction management process a sorting process for grouping payment amounts by credit card number and a calculation process for calculating totals for the sorted payment amounts.

Yet further preferably, the card usage information also includes the payment deadline (due date) for the credit card used for purchases, and the second data processing device also has an input unit for specifying a billing month for the credit card. The processor of the second data processing device in this case calculates the total of all payment amounts, i.e., credit card purchases, that are due by the due date (payment deadline) in the billing month specified using the input unit.

Yet further preferably, the second data processing device also has a storage unit for storing the account number of the settlement account for each credit card used for purchases. The processor of the second data processing device executes as the transaction management process a sorting process for grouping payment amounts by account number, and a calculation process for calculating totals for the sorted payment amounts.

Yet further preferably, the card usage information includes the payment deadline for paying the balance due on each credit card used for purchases. In this case the second data processing device also has an input unit for specifying a billing month for the credit card, and the storage unit of the second data processing device further stores balance data for the settlement account. The processor of the second data processing device calculates the total of payment amounts included within the payment deadline in the billing month specified using the input unit, compares the total of payment amounts due by the payment deadline in the specified billing month with the account balance, and determines and reports if the total amount due can be debited from the settlement account.

Yet further preferably, card usage information includes a product name for which payment was made or a store name to which payment was made, and information relating to the payment method of the credit card used to make a purchase. The second data processing device can print or display this information and the purchase amounts read from the portable storage device.

The first data processing device and second data processing device can contactlessly read and write the card usage information to the portable storage device. The portable storage device is therefore preferably a contactless IC card.

A data processing method according to the present invention uses a portable storage device comprising a rewritable nonvolatile memory unit for storing card usage information for one or more credit cards used to make purchases. When a purchase is made with a credit card, card usage information about the purchase is generated and written to the portable storage device. Card usage information for each credit card written to the portable storage device can later be read, and a transaction management process based on the read card usage information can be run.

A computer-readable recording medium according to the present invention records a program whereby a second data processing device executes a read process for reading card usage information from a portable storage device to which card usage information is written by a first data processing device for one or more credit cards used for purchases, and a transaction management process based on card usage information read by the read process.

[Effect of the Invention]

When a credit card is used with the data processing system according to the present invention described above, a first data processing device generates card usage information relating to the credit card charge and writes the card usage information to a portable storage device. Based on the card usage information read from the portable storage device, a second data processing device runs a transaction management process. Because the card usage information is written automatically to the portable storage device when shopping using only a credit card and portable storage device, it is no longer necessary to receive and keep numerous paper credit card receipts, and the credit card balance due at the end of a specified billing period (also called the settlement amount or the amount due below) can be calculated without using a manual calculator. The work involved with managing credit card usage is therefore made significantly easier.

If the user has and uses multiple credit cards, card usage information for each of the multiple credit cards can be written to a single portable storage device and managed by the second data processing device. Managing the use of multiple credit cards is therefore significantly easier.

Furthermore, when the credit card number and billing month are specified, the data processing system of this invention can run a calculation process whereby the second data processing device identifies the closing date of the billing month, identifies and totals all card usage information records for purchases (payments) made by the closing date, and reports the calculated total as the amount due (settlement amount) for the specified billing month of the specified credit card. Unlike conventional reconciliation processes in which a manual calculator is used to calculate the current balance of credit card charges to be paid, credit card usage can be monitored and the credit card statement reconciled more easily, and an insufficient funds condition in which the amount due cannot be debited because of an error calculating the balance due can be avoided.

When a payment deadline preset relative to the due date for a credit card bill arrives, the second data processing device of this data processing system reports to the user that the deadline has come. Because the user can therefore be reliably made aware that the amount due will be debited from the registered settlement account, an insufficient funds condition preventing the amount due from being debited and paid can be avoided.

Furthermore, because the second data processing device of this data processing system runs a process to calculate the amount due and determines and reports whether the settlement amount can be debited from the settlement account on the due date based on the account balance and the amount due, the user only needs to present the portable storage device each time the credit card is used and then retrieve (read) the card usage information from the portable storage device to the second data processing device, thereby eliminating most of the work involved in reconciling statements and paying for credit card charges. The burden imposed on the cardholder by using a credit card is therefore greatly reduced.

The second data processing device can also receive balance information relating to the current balance of the settlement account registered for each credit card from an external system over a communication network. Compared with conventional methods whereby the user updates a bank book and then manually enters the account balance to an accounting program, for example, the method of the invention reliably avoids balance data entry errors, and makes it easier to know the account balance and whether the amount due on the credit card bill can be paid.

Furthermore, the first data processing device and second data processing device of the data processing system according to the present invention can contactlessly read and write the card usage information to the portable storage device, and can therefore read/write the card usage information to the portable storage device by simply placing the portable storage device on top of the card reader/writer, for example. Compared with methods that read/write the card usage information by physical contact with the communication contacts of a contact-type portable storage device, the data processing system of this invention eliminates much of the work for the person using the first data processing device, and avoids card usage information read/write errors resulting from a poor connection due to worn electrode contacts.

Furthermore, because the first data processing device of the data processing system according to the present invention writes purchase payment information to a portable storage device, this payment information can be used for bookkeeping and accounting processes, and the sales receipts and credit card receipts that can result in an overstuffed wallet are no longer necessary.

The second data processing device of this data processing system can also read the payment information written to the portable storage device and print or display the product or store name, purchase date, and amount paid. Even though the store does not issue a paper receipt, the second data processing device or payment information managing system can print or display the payment information content so that the user can reliably and easily check for transaction errors and whether product discounts have been correctly credited and calculated, for example.

The first data processing device can also write payment information to the portable storage device for purchases paid for by a method other than a credit card, and the payment information managing system can run a specific accounting process based on this payment information. Paper receipts can therefore also be eliminated for purchases made with cash or electronic money, for example. Furthermore, compared with manually maintaining a budget ledger based on information printed to paper receipts, for example, the second data processing device can quickly and reliably record transactions in an account ledger.

Furthermore, by reading/writing card usage information to a card-type storage medium as the portable storage device of the accompanying claims, the data processing system of this invention greatly reduces the burden on the user compared with using a large-scale dedicated data storage device because a thin card-type storage medium is light and easy to carry.

By installing a data processing program according to the present invention to a personal computer (digital terminal) in the home, for example, the personal computer can execute a read process for reading multiple card usage information records from the portable storage device, and a transaction management process including a sorting process for sorting the read card usage information records by credit card and a calculation process for calculating the total amount paid for purchases recorded in the card usage information records meeting specific criteria. A general purpose digital terminal can therefore be used as the second data processing device of the data processing system according to the present invention, and can run a transaction management process relating to credit card use.

This data processing program can also be recorded to a computer-readable recording medium. This recording medium can then be used to install the data processing program to a digital terminal that cannot be connected to the Internet or other network environment.

Yet further, by reading/writing the card usage information to a card-type storage medium as the portable storage device in the accompanying claims of the invention, the data processing program of this invention greatly reduces the burden on the user when compared with using a large-scale dedicated data storage device.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of a data processing system 1 according to a preferred embodiment of the invention;

FIG. 2 is a block diagram showing the configuration of the IC card 10 in the data processing system 1;

FIG. 3 is a block diagram showing the conceptual structure of the data blocks B in the data memory 13 of this IC card 10;

FIG. 4 is a block diagram showing the configuration of the card reader/writer RW in this data processing system 1;

FIG. 5 is a block diagram showing the configuration of the user terminal 22 in merchant terminal 2a;

FIG. 6 shows an example of a receipt 19 printed by the user terminal 22 or personal computer 45;

FIG. 7 shows an example of the data structure of transaction management data Dc1 stored to the personal computer 45 of the user terminal 4;

FIG. 8 shows an example of the data structure of transaction management data Dc2 stored to the personal computer 45 of the user terminal 4;

FIG. 9 is a flow chart of the data writing process 50 run by the POS terminal 21 of merchant terminal 2a and cash register 25 of merchant terminal 2b;

FIG. 10 is a flow chart of the card authorization process 60 run by POS terminal 21, user terminal 22, cash register 25, and personal computer 45;

FIG. 11 is a flow chart of the data retrieval process 70 run by the personal computer 45 of the user terminal 4;

FIG. 12 is a flow chart of the payment information reporting process 80 run by the personal computer 45 of the user terminal 4;

FIG. 13 is a flow chart of the deposit process 90 run by the user terminal 22 of merchant terminal 2a; and

FIG. 14 is a flow chart of the payment process 100 run by the POS terminal 21 of ant terminal 2a and cash register 25 of merchant terminal 2b.

### KEY TO THE FIGURES

1 data processing system

2a, 2b merchant terminal

3a, 3b card company terminal

4 user terminal

5a, 5b bank terminal

6 web server

10 IC card

13 data memory

21 POS terminal

22 user terminal

23 store server

25 cash register

41a, 41 b, 2a, 42b server

45 personal computer

50 data writing process

70 data retrieval process

80 payment information reporting process

B1 receipt data block

B3 system data block

C optical recording medium

Da report data

Db balance data

Dh usage history data

Di ID data

Dr receipt data

Dc1, Dc2 transaction management data

N1 public network

P accounting program

RW card reader/writer

### DESCRIPTION OF THE PREFERRED EMBODIMENTS

Preferred embodiments of a data processing system, data processing program, and recording medium storing the program according to the present invention are described below with reference to the accompanying figures.

Configuration of the Data Processing System

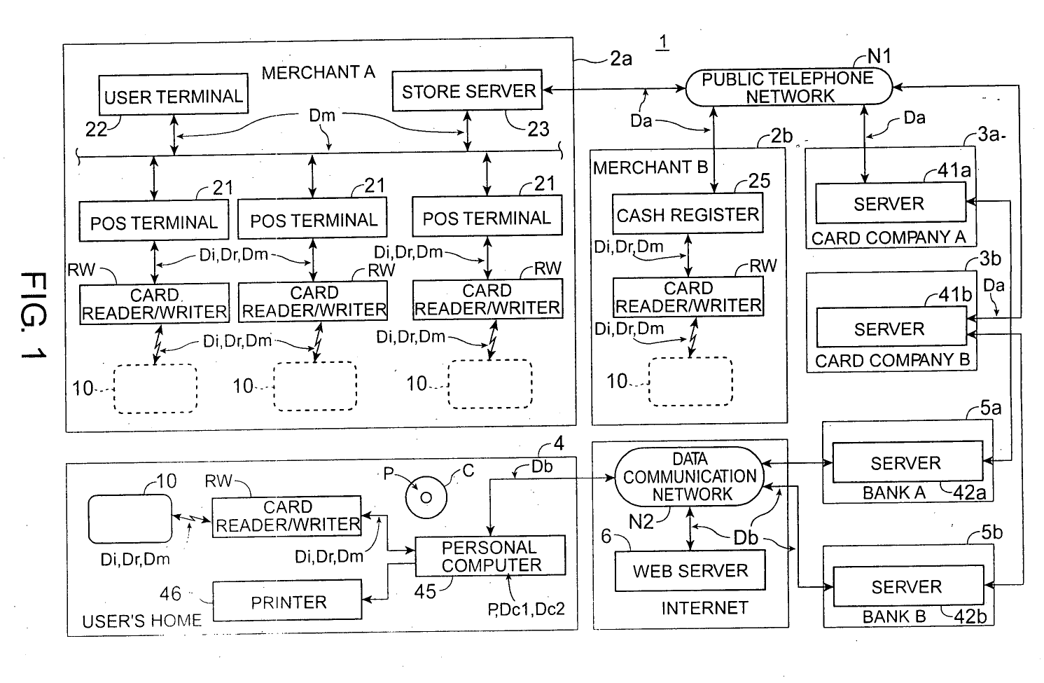

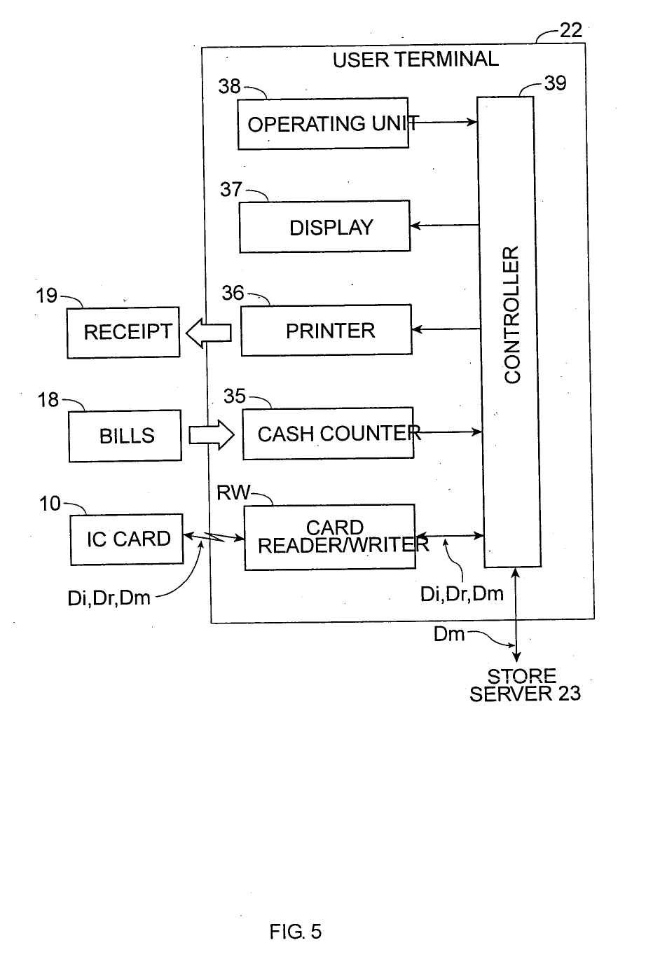

The configuration of a data processing system 1 according to the present invention is described first below with reference to FIG. 1 to FIG. 7.

As shown in FIG. 1 this data processing system 1 is configured so that it can execute data processes using an IC card 10, a card-type data storage medium used as the portable storage device in the accompanying claims of the invention.

The data processing system 1 has merchant terminals 2a, 2b (referred to below as merchant terminal 2 unless referring to the terminal in a particular store) installed in retail stores A and B where sales transactions are processed, and a user terminal 4 typically installed in the user's home. While only two merchant terminals 2 and one user terminal 4 are shown in FIG. 1 to simplify describing the present invention, it will be apparent that a typical application will have numerous merchant terminals 2 and user terminals 4. It is further assumed below that the user has already contracted with credit card companies A and B (referred to as the card companies below) and therefore has multiple credit cards including a credit card issued by card company A and a credit card issued by card company B. The user also has an account at bank A that is registered for automatic debiting by card company A to pay the balance due on the credit card issued by card company A, and another account at bank B similarly registered for automatic debiting by card company B to pay the balance due on the credit card issued by card company B.

In this scenario card companies A and B each maintain a card company terminal 3a, 3b (referred to below as card company terminal 3 unless referring to the terminal in a particular card company). A bank terminal 5a, 5b (referred to below as bank terminal 5 unless referring to the terminal in a particular bank) for managing information including account balance information is also maintained by banks A and B where the user has accounts.

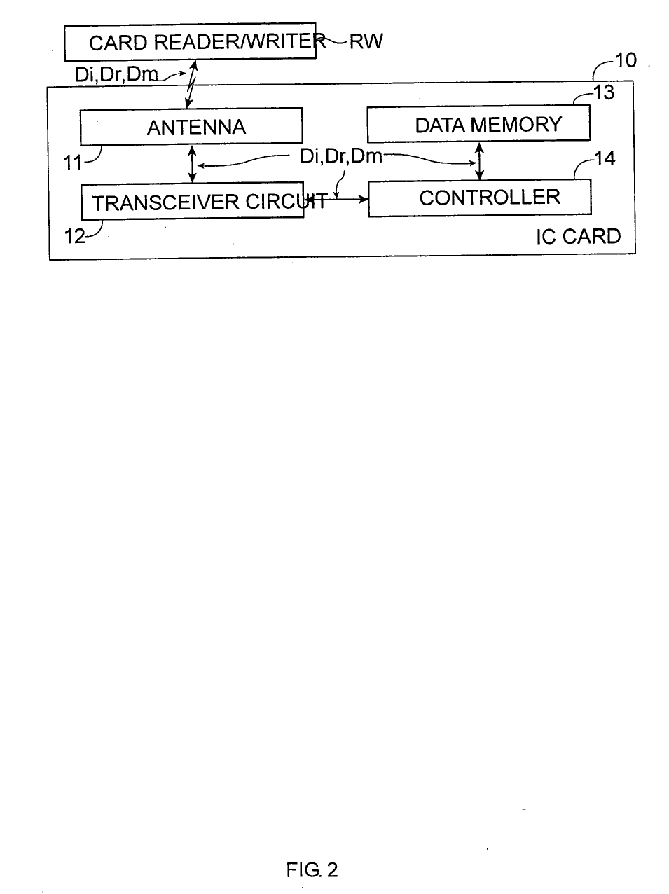

The IC card 10 is also a contactless data storage card issued to a specific user. As shown in FIG. 2 the IC card 10 has an antenna 11, transceiver circuit 12, data memory 13, and controller 14. The transceiver circuit 12 communicates receipt data Dr, electronic money data Dm, and ID data Di with a card reader/writer RW through the antenna 11. This is done by the IC card 10 sending a response signal (such as ID data Di) to a polling signal sent from an external device (such as card reader/writer RW). Data is also encrypted for transmission between the IC card 10 and card reader/writer RW in order to protect the data and prevent unauthorized access to the IC card 10.

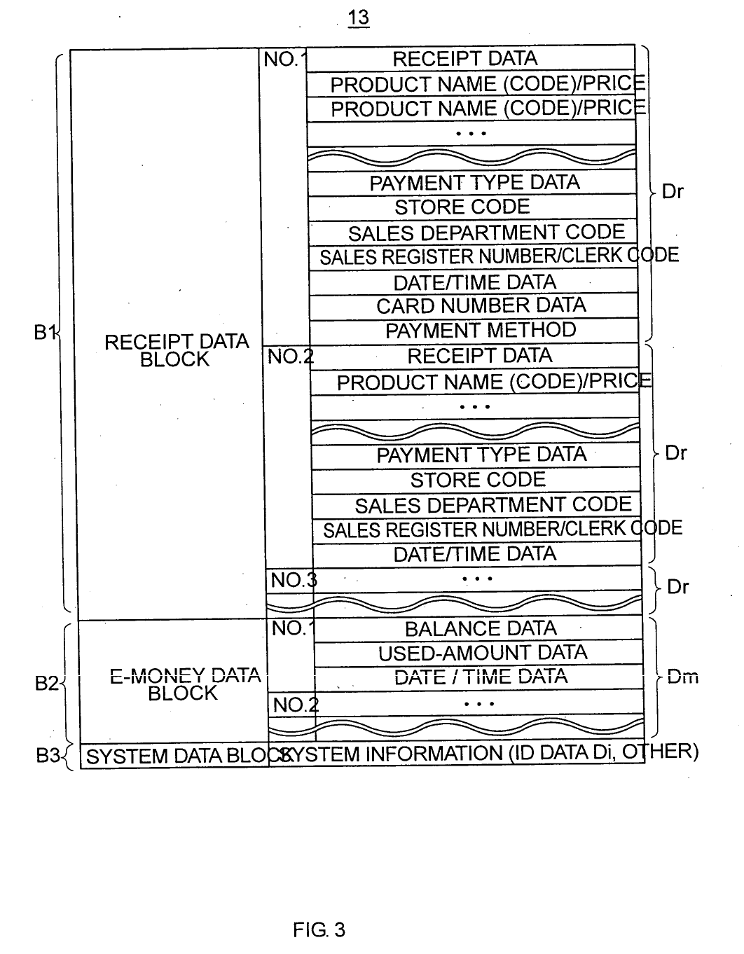

The data memory 13 corresponds to the nonvolatile storage unit of the accompanying claims, and may be EEPROM, FERAM, or other type of nonvolatile memory device. As shown in FIG. 3 this data memory 13 has three data blocks B: receipt data block B1 to which multiple receipt data Dr records are written, electronic money (“e-money” below) data block B2 for writing e-money data Dm records, and system data block B3 for writing ID data Di and other system data.

The receipt data Dr corresponds to the card usage information in the accompanying claims, and each receipt data Dr record includes such fields as the receipt number, product name, item code, price (payment amount), payment type (cash, e-money, credit card), store name or store code (including telephone number), sales counter code, sales register number, salesperson code, date and time (payment date information), card number, and payment method information.

The e-money data Dm includes multiple usage records containing a balance data field indicating how much of the amount prepaid on the card is left, the amount used, and data information.

The ID data Di is a unique identification number written to the IC card 10 when the card is issued.

The controller 14 controls sending and receiving the receipt data Dr, e-money data Dm, and ID data Di to and from the transceiver circuit 12, and controls writing and reading the receipt data Dr to data memory 13. This IC card 10 also has a power supply circuit not shown in the figures, and the various parts of the IC card 10 are operated with power supplied by electromagnetic induction, for example.

It should be noted that this IC card 10 could be issued and provided by a software publisher as part of home accounting program P, further described below, by an application service provider (ASP), or by a credit card company or bank.

Furthermore, this data processing system 1 is jointly managed by retail stored, card companies, banks, and software publishers to provide various services using IC cards 10.

Large-scale merchant terminal 2a is designed for relatively large stores with multiple sales departments, and as shown in FIG. 1 has multiple POS terminals 21 (electronic cash register terminals) installed in each department, a user terminal 22, and a store server 23 connected through a LAN. Connected to each POS terminal 21 are a card reader/writer RW for sending and receiving (writing and reading) the receipt data Dr, e-money data Dm, and ID data Di to IC card 10, a card reader (not shown in the figure) for reading a credit card number from the magnetic stripe on the credit card, and a barcode reader (also not shown) for reading the barcode containing product code information affixed to each product. Note this card reader and barcode reader are known from the literature and further description thereof is thus omitted.

Together with the card reader/writer RW, card reader, and store server 23, the POS terminal 21 forms the first data processing device of the accompanying claims, and runs processes including a transaction process for payment by credit card or cash, a transaction process for payment using prepaid funds stored on an IC card 10 (a data process using e-money data Dm), and a receipt printing process (outputting receipt data Dr). When payment using a credit card is completed, the POS terminal 21 assembles and sends to the store server 23 a record containing the number of the credit card used for payment, the payment method (single payment, multiple payments, revolving credit payment, or deferred payment, for example), and the payment amount.

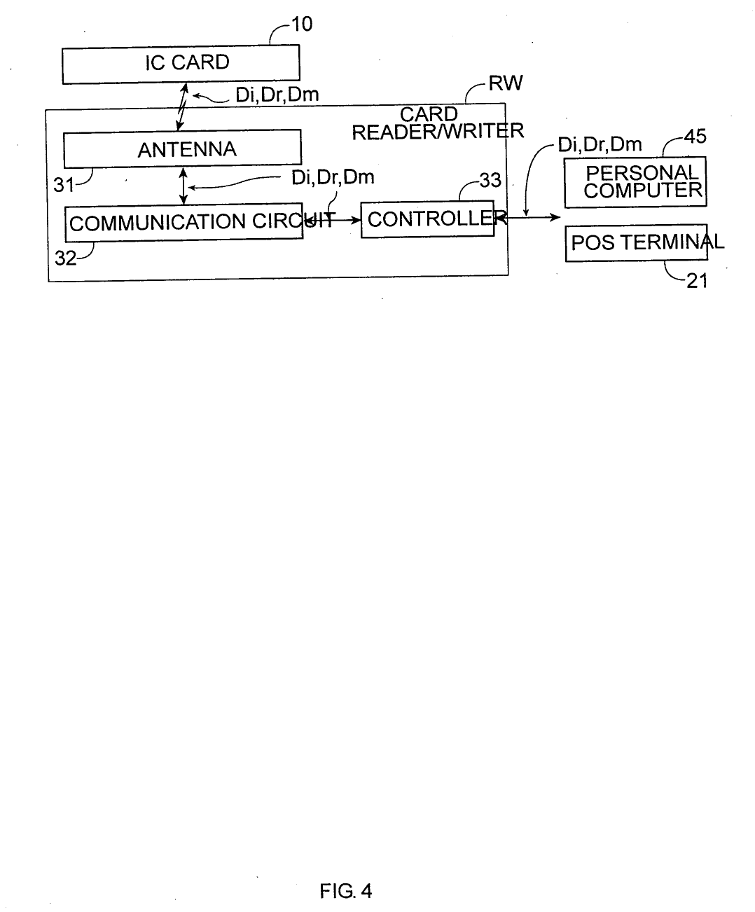

The card reader/writer RW is for contactlessly communicating (reading and writing) the receipt data Dr with the IC card 10, and has an antenna 31, communication circuit 32, and controller 33 as shown in FIG. 4. The communication circuit 32 exchanges receipt data Dr, for example, with the IC card 10 through antenna 31. The controller 33 controls the communication circuit 32 for sending and receiving the receipt data Dr.

The card reader/writer RW also has a power supply circuit not shown for contactlessly supplying power to the IC card 10. This card reader/writer RW is connected to the USB port or serial port of POS terminal 21 and user terminal 22 or personal computer 45 further described below in order to send and receive the receipt data Dr. This card reader/writer RW communicates receipt data Dr with an IC card 10 located within a 10 cm range of the antenna 31 using a 125 kHz or data memory 13.56 MHz carrier wave.

The user terminal 22 can display or print product name and price information, for example, based on the receipt data Dr written to IC card 10 as described below. This enables confirming transaction errors, product discount errors, and the like while at merchant A.

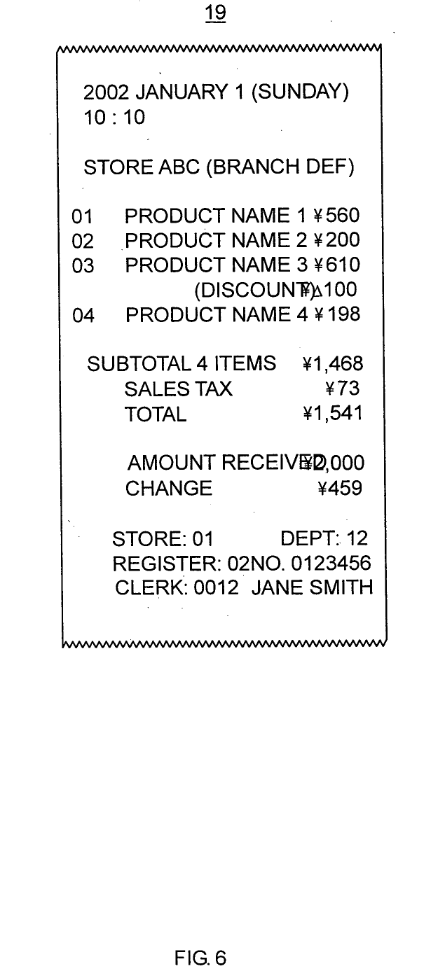

More specifically, the user terminal 22 has a card reader/writer RW, cash counter 35, printer 36, display 37, operating unit 38, and controller 39. The cash counter 35 counts bills 18 inserted by the user to a deposit window not shown, and reports the total deposit amount to the controller 39. The printer 36 is controlled by the controller 39 and prints deposit receipts (receipt 19 shown in FIG. 6) for prepaid funds, and payment receipts (receipt 19) based on the receipt data Dr written to the IC card 10. The display 37 displays the prepaid amount and payment details based on the receipt data Dr written to the IC card 10.

The operating unit 38 has various buttons for operating the user terminal 22. The controller 39 controls communicating receipt data Dr and other information with the card reader/writer RW, controls operation of the cash counter 35, controls printing and displaying by the printer 36 and display 37, and reports the results of the various processes to the store server 23.

As is the personal computer 45 of the user terminal 4 described below, this user terminal 22 is an embodiment of the second data processing device in the accompanying claims.

The store server 23 is the central controller of all POS terminals 21 and user terminals 22 in the store (merchant A in this example). The store server 23 also stores the product data (such as the product name and price information for a specific product code) used for the transaction processes by each POS terminal 21. The store server 23 also generates report data Da uniquely identifying when (payment date) how much (payment amount) was charged to what credit card (credit card number) based on information reported from the POS terminal 21, and directly outputs the report data Da via public network N1 to the card company terminal 3 appropriate to the credit card that was used as shown in FIG. 1. It should be noted that a shared server could be located between the store server 23 and card company terminal 3 so that the store servers 23 send the report data Da to the appropriate card company terminal 3 through this shared server.

As also shown in FIG. 1, the small-scale merchant terminal 2b has a cash register 25 to which is connected a card reader/writer RW, a card reader (not shown) for reading the credit card number from the magnetic stripe on a credit card, and a barcode reader (not shown) for reading the barcode affixed to each product. This merchant terminal 2b is designed for a relatively small merchant with only one sales department, and the cash register 25 combines the function of both the POS terminal 21 and store server 23 in merchant terminal 2a described above.

More specifically, the cash register 25 stores the product data used for processing sales transactions, and processes sales transactions and issues receipts (outputting receipt data Dr) in the same way as POS terminal 21. When payment by credit card is completed, this cash register 25 also generates the report data Da uniquely identifying when how much was charged to what credit card, and sends this report data Da directly over the public network N1 to the card company terminal 3 corresponding to the credit card that was used.

Also like the merchant terminal 2a described above, the cash register 25, card reader/writer RW, and card reader together form the first data processions device in the accompanying claims.

It should be noted that the large-scale merchant terminal 2a and small-scale merchant terminal 2b could also use a CAT in place of or in conjunction with POS terminal 21 and cash register 25.

The user terminal 4 is installed in the home, for example, of the user/owner of the IC card 10, and has a card reader/writer RW and personal computer 45 to which a printer 46, monitor (not shown), and keyboard (input device) are connected. In this configuration the personal computer 45 is the second data processing device of the accompanying claims, and can connect to an Internet web server 6 over data communication network N2. In this case the web server 6 stores digital content for websites operated by banks A and B, for example. The bank website typically contains advertising content relating to the bank's services and products, directory content relating to bank locations and holidays, and Internet banking content enabling an account holder to check account balances and make payments and transfers, for example. This Internet banking content enables the user to view or download the most recent balance data Db based on the account balance information maintained by the bank terminal 5 in each bank A, B.

Based on receipt data Dr read from IC card 10 by card reader/writer RW, the personal computer 45 prints transaction content from printer 46 or displays the information on a monitor (not shown).

A home accounting program P is installed on the personal computer 45. By running this accounting program P on the personal computer 45, information about the use of each credit card written to the IC card 10 can be read from the IC card 10, and payments and credit card use can be managed based on the card usage information read from the IC card 10. The CPU and memory to which program P is loaded in personal computer 45, the interface to the card reader/writer RW and other internal circuits, and the program P constitute the processing unit of the second data processing device of the accompanying claims.

The accounting program P could be sold in a store as packaged software recorded to optical recording medium C as the recording medium in the accompanying claims, or it could be sold over the Internet for downloading from the website of the software publisher, for example.

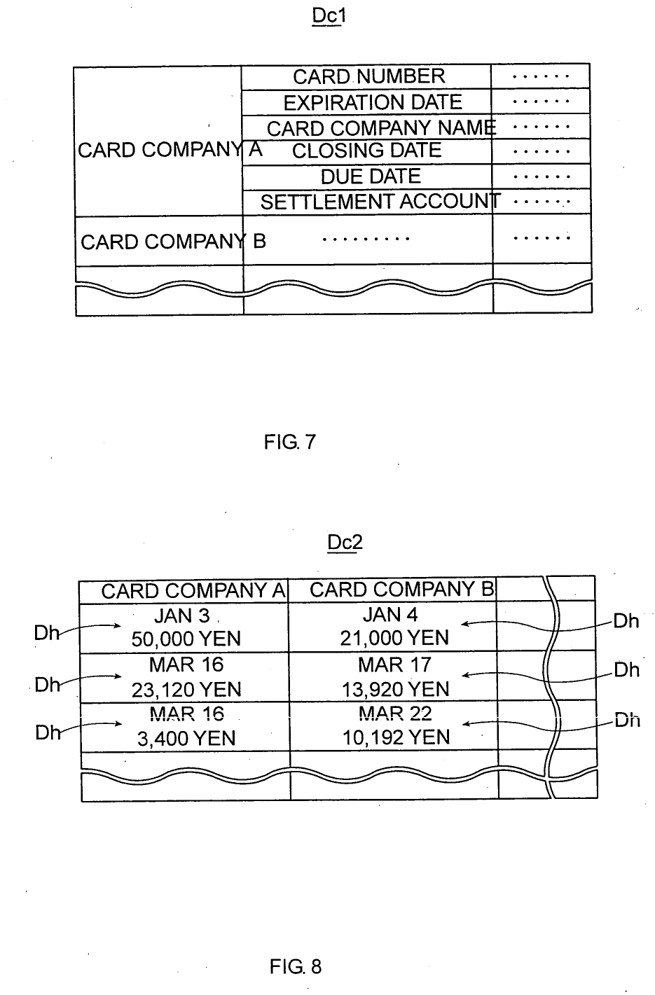

Transaction management data Dc1, Dc2 for each credit card owned by the user is stored to an internal hard disk (equivalent to the storage unit of the second data processing device in the accompanying claims) in the personal computer 45. As shown in FIG. 7, transaction management data Dc1 in this case records information about the card number, expiration date, card company name, billing period, payment due date, and account debited for payment. This information is kept for each credit card owned by the user, or more specifically for each company that issued the cards.

As shown in FIG. 8, transaction management data Dc2 records usage history data Dh organized by credit card (card company). This usage history data Dh contains information about payments made with the particular credit card, including the date and amount of charges made. Balance data Db downloaded from a web server 6 for a particular card is also recorded to the internal hard disk drive of the personal computer 45.

The personal computer 45 runs transaction management processes according to the installed accounting program P. These processes include a sorting process for sorting payment amounts by credit card number or account number, a calculation process for obtaining the totals for the sorted payments, a calculation process for totalling all charges made within the billing cycle, and a process for totalling all charges in a specified billing cycle (month), comparing the total of all payments due in the specified billing cycle with the current account balance, determining if the account balance is sufficient to make the payment, and reporting to the user.

More specifically, the personal computer 45 reads the receipt data Dr from the IC card 10 as directed by the accounting program P to manage the usage history of the credit cards owned by the user based on the read receipt data Dr. When the predefined due approaches, the personal computer 45 sends a message to a preregistered destination (such as the cell phone number of the user or the e-mail address of the cell phone) to tell the user that the due date is near.

Based on receipt data Dr read from IC card 10, the personal computer 45 prints or displays the receipt number, purchased products (the name of the product paid for), the cost (amount paid), payment type (cash, e-money, or credit card), merchant code (including the phone number), sales department code, register number, clerk ID code, and date (payment date). The personal computer 45 can also subtotal the purchases according to predefined categories.

It will be obvious that the user terminal 4 is not limited to being installed and used in the user's home, and could be in the user's office, in which case a business computer could be used.

The card company terminal 3a has a server 41a for managing information relating to the use of credit cards issued by card company A, and card company terminal 3b has a server 41b for managing information relating to the use of credit cards issued by card company B. Based on the report data Da received from the merchant terminals 2a, 2b over the public network N1, the servers 41aand 41b (referred to below as server 41 unless referring the server in a specific card company) generate and store tracking data uniquely identifying for each transaction when (payment date) how much (payment amount) was paid to whom (the name of the store where the purchase was made) on what credit card (credit card number). After the billing cycle cut-off date, the server 41 totals how much was used on each credit card, and prints a debit notice including the total payment due and the scheduled payment (debit) date. The printed debit notice (credit card bill) is then mailed by the card company to the cardholder (user).

Bank terminal 5a comprises server 42a in bank A, and bank terminal 5b comprises server 42b installed in bank B. These servers 42a, 42b (referred to as server 42 below unless referring to the server of a specific bank) manage account information for a large number of accounts, including the account of the cardholder (user), run processes for handling deposits by the user to the user's account and withdrawals from accounts belonging to the user, and stores the account history. The servers 42a, 42b can also be connected to the server 41 of the card company terminal 3 over the public telephone network, for example, process account debits based on debit request information sent from the server 41, and send debit completion reports to the server 41.

Data Writing Process

A method for processing receipt data Dr in a data processing system 1 according to this first embodiment of the invention is described next with reference to the accompanying figures.

The user takes both a credit card and IC card 10 when shopping at store A, for example. If e-money data Dm has been previously loaded into the IC card 10, then the IC card 10 alone could be used for shopping. Loading and using e-money in IC card 10 is described further below while using a credit card is assumed here.

The user (shopper) then presents the desired products and the credit card issued by card company A to the checkout clerk in store A, and holds the IC card 10 within the communication range of the card reader/writer RW connected to POS terminal 21. This could be done by, for example, simply setting the IC card 10 on the card reader/writer RW. Because a credit card is used in this example, a transaction process for charging the purchase amount to the credit card is run. More specifically, the clerk enters the product code for each purchased product to the POS terminal 21 by scanning the product barcodes, and then reads the credit card number by swiping the magnetic stripe on the credit card through the credit card reader. The POS terminal 21 then sends the product code information to the store server 23. The store server 23 then searches the product database and returns the product name and price information for the product codes received from the POS terminal 21 back to the POS terminal 21.

The clerk then enters or has the customer enter to the POS terminal 21 the type of payment to be charged to the credit card (e.g., charge the full amount for single payment), and presses a SEND button to send a transaction record containing at least the number of the credit card to be charged, the charge method, and amount (purchase total) to the store server 23.

Based on the transaction record received from the POS terminal 21, the store server 23 generates report data Da for reporting the content of the credit card transaction to the card company A, and sends the report data Da via public network N1 to the server 41aof the card company terminal 3a.

Based on the received report data Da, the server 41agenerates and stores a transaction record (management information) containing the credit card number, payment method, charge amount, date, and where the card was used. This completes the transaction process for payment using the credit card (confirms the credit card charge).

It should be noted that the report data Da does not need to be sent from the store server 23 to the server 41aevery time a purchase is paid for using a credit card. More specifically, multiple transaction records output from different POS terminals 21 (that is, multiple report data Da records) could be sent by batch transmission at predetermined time intervals.

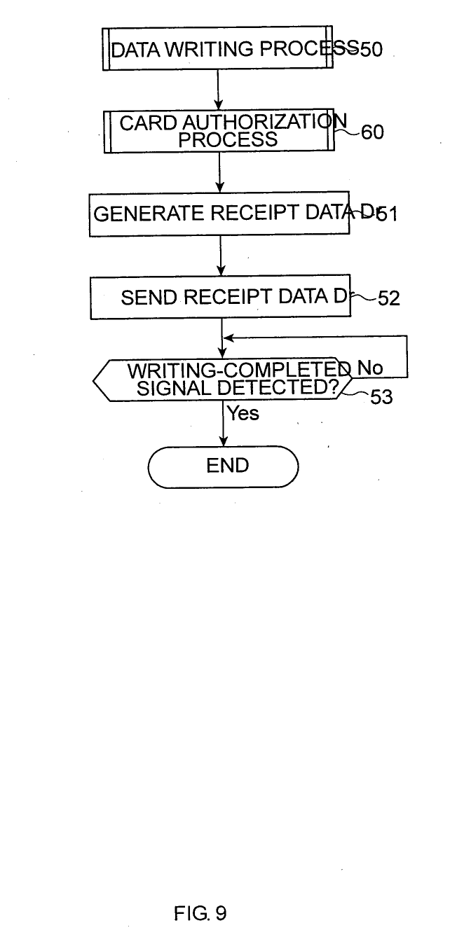

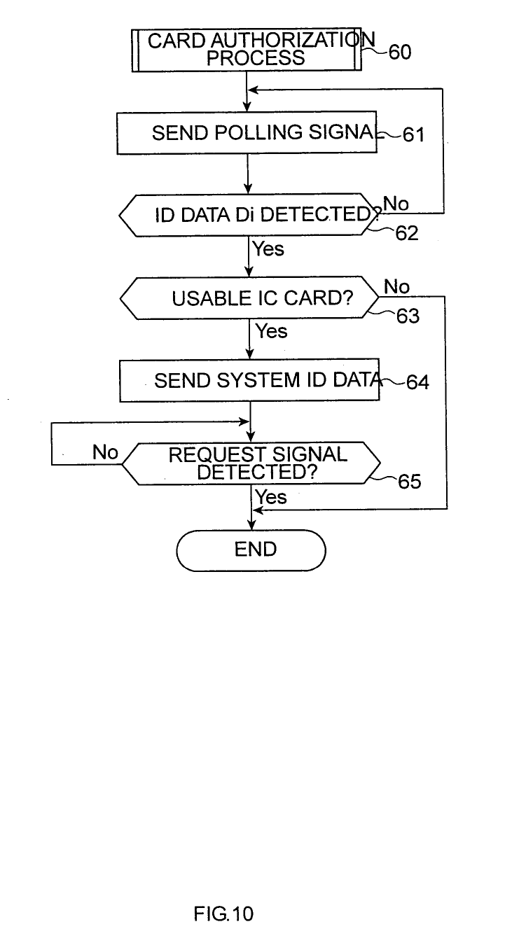

The POS terminal 21 then executes the data writing process 50 shown in the flow chart in FIG. 9. This data writing process 50 starts with the card authorization process 60 shown in FIG. 10 as described below.

The card authorization process 60 starts with the POS terminal 21 sending a polling signal to the card reader/writer RW (step 61). When the transceiver circuit 12 of the IC card 10 thus receives a polling signal through the antenna 11, it tells the controller 14 that a polling signal was received. The controller 14 then reads the ID data Di from system data block B3 in data memory 13, and sends the ID data Di to transceiver circuit 12.

After sending the polling signal the POS terminal 21 monitors whether the ID data Di was sent from the IC card 10 (step 62), and continues sending the polling signal to the card reader/writer RW until ID data Di transmission is confirmed (step 61).

When the ID data Di is sent by the IC card 10, POS terminal 21 confirms whether the IC, card 10 can be used or not based on the received ID data Di by, for example, detecting if the card is compatible with data processing system 1 and detecting if IC card 10 usage is restricted (step 63).

If the IC card 10 that sent the ID data Di is determined unusable, the POS terminal 21 sounds an audible alert and displays a message saying that the IC card 10 cannot be used, and the card authorization process 60 ends by generating an error.

However, if the IC card 10 is determined usable, the POS terminal 21 sends system ID data to the card reader/writer RW (step 64). Based on the system ID data received by the transceiver circuit 12, the controller 14 of the IC card 10 detects if the terminal that output the system ID data (the POS terminal 21 in this example) is compatible with the IC card 10. If it is compatible, the controller 14 tells the transceiver circuit 12 to send a request signal to continue the process.

The POS terminal 21 then monitors if this request signal was sent from the IC card 10 (step 65). If the request signal is detected, the POS terminal 21 sounds an authorization completion alert, displays a message that the IC card 10 can be used, and ends the card authorization process 60. This completes the authorization process between the POS terminal 21 and IC card 10.

If the card authorization process 60 ends without generating an error and control returns to the data writing process 50, POS terminal 21 generates receipt data Dr for the purchased products (step 51). The receipt data Dr generated by the POS terminal 21 includes product name and price data, card number data identifying the number of the credit card used for payment, and payment method data identifying the type of payment to be charged to the credit card. Based on the card number read from the credit card by the card reader the POS terminal 21 generates the credit card number data and generates the receipt data Dr. POS terminal 21 then sends this receipt data Dr to the card reader/writer RW (step 52).

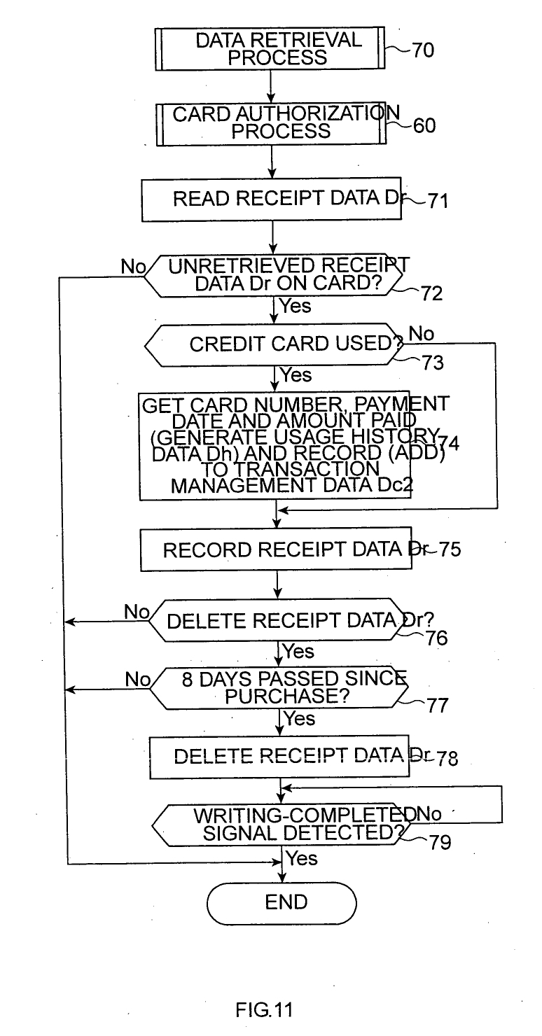

The controller 14 of the IC card 10 then writes the receipt data Dr received by transceiver circuit 12 to receipt data block B1 in the data memory 13. If there is insufficient space (writable area) in the receipt data block B1 of data memory 13 to write the receipt data Dr, the controller 14 tells the transceiver circuit 12 to send a signal reporting insufficient storage space. This causes the POS terminal 21 to print a receipt 19 containing receipt information for the purchased products, a message indicating that there is insufficient memory available in the card, the card number of the used credit card and other such information, and then ends the data writing process 50. After receiving this receipt 19, the user can later transfer the receipt data Dr from the IC card 10 to a personal computer 45 as described in the data retrieval process 70 shown in FIG. 11 so that the receipt data Dr can be used on the personal computer 45.

If there is sufficient storage space in the receipt data block B1 of data memory 13 and receipt data Dr is successfully written, the controller 14 tells the transceiver circuit 12 to output a writing-completed signal after finishing writing the receipt data Dr to data memory 13. After sending the receipt data Dr, the POS terminal 21 monitors if a writing-completed signal is output from the IC card 10 (step 53), and ends the data writing process 50 when the writing-completed signal is detected. This completes writing the receipt data Dr to IC card 10.

Successfully written receipt data Dr can be deleted from the receipt data block B1 after a specified period of time. This frees that memory space for writing new receipt data Dr.

It should be noted that the POS terminal 21 of merchant terminal 2a writes the receipt data Dr to IC card 10 when shopping at store A in the above example. When shopping at store B, however, the cash register 25 of the merchant terminal 2b operates instead of POS terminal 21 and store server 23 to control writing the receipt data Dr to the IC card 10 and sending the report data Da to the card company. Therefore, when a credit card is used to shop at store A or B or a store (not shown in the figures) like store A or B, the receipt data Dr recording the number of the credit card used, the payment method, and charge amount is written to the data memory 13 of IC card 10 when the IC card 10 is also presented, and a transaction record storing information about each credit card use (management information) is recorded to the server 41 of the card company terminal 3.

If a credit card receipt signed by the cardholder is required by the store when paying for a purchase with a credit card, this receipt can be printed by the POS terminal 21 or cash register 25 printer. Furthermore, this data processing system 1 for writing receipt data Dr to an IC card 10 does not, in principle, issue a paper receipt when a purchase is made. Therefore, if a paper receipt is required the customer can ask to have a paper receipt printed by the printer of the POS terminal 21 or cash register 25 when paying for the purchase. A receipt 19 (see FIG. 6) could also be printed using a printer 46 connected to a personal computer 45 used as the user terminal 4 or by the user terminal 22 of the merchant terminal 2a based on the receipt data Dr written to IC card 10.

If cash is used instead of the credit card in the above example to pay for a purchase, the POS terminal 21 or cash register 25 generates receipt data Dr in which the payment type indicates payment by cash and there is no credit card number data or payment method data, and writes this receipt data Dr to IC card 10 through card reader/writer RW. As a result, receipt data Dr for multiple purchases can be written to the IC card 10 regardless of how payment is made.

Data Retrieval Process

As noted above, an accounting program P is assumed to be installed on a personal computer 45 in the home of the user. Based on the receipt data Dr written to IC card 10 the accounting program P can be used on the personal computer 45 to track credit card charges and payments and reconcile the credit card statement with the user's records. To run these processes and enter purchases in the appropriate accounts using this accounting program P, the user starts the accounting program P and brings the IC card 10 within communication range of the card reader/writer RW. The personal computer 45 then starts the data retrieval process 70 (the reading process in the accompanying claims) shown in FIG. 11.

The data retrieval process 70 starts with the card authorization process 60. If the card authorization process 60 ends successfully without generating an error, the personal computer 45 sends a control signal to the card reader/writer RW to tell the IC card 10 to send the receipt data Dr, and thus reads the receipt data Dr from the IC card 10 (step 71).

The personal computer 45 then determines if there is any unretrieved receipt data Dr in the read receipt data Dr by comparing receipt data Dr that was read (retrieved) before the current data retrieval process 70 and stored to an internal hard disk or other storage device with the receipt data Dr read from the IC card 10 in step 71 (step 72). If there is no unretrieved receipt data Dr detected, the personal computer 45 ends the data retrieval process 70.

If unretrieved receipt data Dr is found, however, whether a credit card was used for the purchase recorded in the receipt data Dr is determined (step 73). More specifically, the personal computer 45 determines according to the instructions of the accounting program P if a credit card was used based on the payment type data in the receipt data Dr.

If the receipt data Dr is thus determined to relate to a purchase made with a credit card, the personal computer 45 detects the card number data (credit card number), payment date information, and the total of the purchased products (charge amount) in the receipt data Dr to generate a usage history data Dh record containing this information. This usage history data Dh is then written to the internal hard disk as transaction management data Dc2 for the specific credit card (card number) (step 74).

This process for sorting the usage history data Dh by credit card (credit card number) and adding it to the transaction management data Dc2 is an example of the sorting process of the accompanying claims.

It will also be noted that the usage history data could be sorted by the account used to pay the credit card bill and stored as transaction management data Dc2. If the same bank account is thus used to pay the balance due on multiple credit cards, this method enables the total due for each credit card to be sorted and tallied by bank account.

The personal computer 45 writes the receipt data Dr read from the IC card 10 to the internal hard disk when a credit card is not used (step 73 returns no) because cash was used, for example, and when recording the transaction management data Dc2 in step S74 is completed (step 75). The accounting program P then sorts and records the receipt data Dr in chronological order by payment (purchase) date based on the payment date information in the receipt data Dr.

The personal computer 45 then detects if there is an instruction to delete the receipt data Dr read in step 71 from the IC card 10 (step 76). If the receipt data Dr is not to be deleted, the data retrieval process 70 ends. If the user has directed deleting the receipt data Dr, however, the personal computer 45 determines if eight days, for example, have passed since the payment recorded in the receipt data Dr selected for deletion based on the payment data information in the receipt data Dr and the current date read from an internal clock (step 77). If less than eight days in this example have passed since the payment indicated in the receipt data Dr selected for deletion, the personal computer 45 ends the data retrieval process 70 without deleting the data.

This makes it possible to return products based on the receipt data Dr written in IC card 10 or to reverse a transaction within the cooling-off period. If eight days have passed since the payment indicated in the receipt data Dr selected for deletion, the personal computer 45 sends a control signal for deleting the receipt data Dr to the card reader/writer RW to erase the indicated receipt data Dr from the IC card 10 (step 78).

The number of days used to determine whether the receipt data Dr can be deleted or not, i.e., eight days in this example, can preferably be set as desired by the user in the personal computer 45.

The personal computer 45 then monitors whether a writing-completed signal was sent by the IC card 10 (step 79), and ends the data retrieval process 70 when the writing-completed signal is detected. This completes retrieving (copying) the receipt data Dr written in IC card 10 to the personal computer 45.

The personal computer 45 can then proceed with the bookkeeping process according to the accounting program P to record the retrieved receipt data Dr in the appropriate accounting ledger. More specifically, the personal computer 45 maintains an electronic ledger in the personal computer 45 by organizing and recording information relating to expense amounts according to categories predefined by the user. This electronic ledger can be displayed on the screen of the personal computer 45, and printed by printer 46.

Payment Information Reporting Process

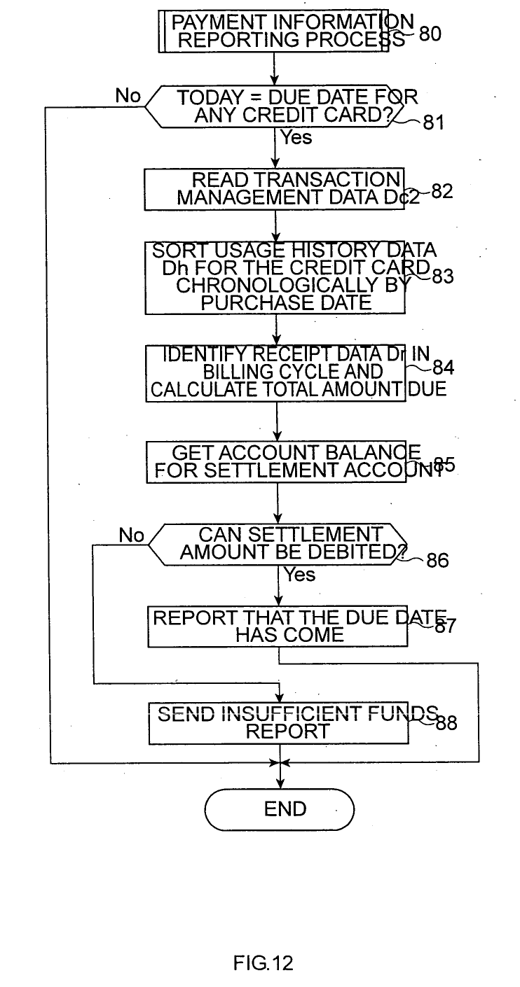

The payment information reporting process 80 shown in FIG. 12 is run at a time determined by the user by the personal computer 45 on which accounting program P is installed. This payment information reporting process 80 is a process for posting to the user a message relating to payments made to a card company, and preferably runs at a predetermined time such as once a day. It is assumed here that the transaction management data Dc1 (information relating to the credit card number, closing date, due date, and the account used for paying the credit card bill) for each credit card used by the user has already been stored to the internal hard disk.

This payment information reporting process 80 starts with the personal computer 45 determining based on the content of the transaction management data Dc1 and the date from the internal clock whether today is the due date for any of the credit cards (credit card numbers) owned by the user (step 81). If the current date is not the due date for any credit card held by the user, the personal computer 45 ends the payment information reporting process 80.

If step 81 determines that the bill for a credit card issued by card company B, for example, is due, the personal computer 45 reads the transaction management data Dc2 from the internal hard disk (step 82). The personal computer 45 then sorts the usage history data Dh for the credit card issued by card company B from the read transaction management data Dc2 in chronological order by purchase date (step 83). Based on the closing date for card company B in the transaction management data Dc1, the personal computer 45 identifies the usage history data Dh corresponding to the purchases to be paid for on the due date in the transaction management data Dc2, and calculates the total of the payments in the identified usage history data Dh records (step 84). Calculating the total payment due is an example of the calculation processes in the accompanying claims. If multiple payments was indicated when the credit card was charged and the charged amount is paid in approximately three equal payments, then approximately ⅓ of the charged amount is used for calculating the total amount due. For simplicity describing and understanding the present invention, however, all purchases (charges) are assumed below to be payable in a single payment.

The personal computer 45 the determines the remaining balance of the account registered for paying the charges to the credit card issued by card company B (step 85). This account is assumed here to be an account at bank B in the name of the cardholder. In this embodiment the personal computer 45 therefore connects to web server 6 over data communication network N2, for example, to access the website of bank B containing Internet banking content. The personal computer 45 then completes a specific verification process (a verification process between the personal computer 45 and web server 6), and receives balance data Db containing the remaining balance of the account belonging to the cardholder. The balance in the account registered for settling with bank B is then determined from the received balance data Db.

It will also be apparent that the invention shall not be limited to getting the balance data Db from a web server 6. The user could, for example, manually enter the account balance, or the account balance could be determined based on information relating to the account balance maintained by the accounting program P.

Based on the total amount due calculated in step 84 and the account balance determined in step 85, the personal computer 45 then determines if the payment due to card company B can be debited from the account of record (the settlement account) in bank B (step 86). If the amount due can be debited, the personal computer 45 sends an e-mail message to the effect that “the due date for card company B has come” to a pre-registered address (such as the e-mail address of a cell phone used by the cardholder) (step 87). The payment information reporting process 80 then ends.

If the balance is insufficient for debiting the amount due, the personal computer 45 sends to the cell phone e-mail address in this example an e-mail message telling the cardholder that the due date for card company B has come but the account balance is insufficient and payment is not possible (step 88). The payment information reporting process 80 then ends. The cardholder thus knows from the e-mail message sent to his cell phone that there are not sufficient funds, and can transfer enough money to assure that payment is made. The balance due on the credit card issued by card company B can therefore be debited from the cardholder's account and transferred to card company B.

The accounting program P can also send e-mail messages and handle other communications for the payment information reporting process 80 at a time predetermined by the user. More specifically, the process described above sends a separate e-mail message reporting whether the amount due can be debited from the registered account on the due date for each card company, but the accounting program P could be configured to, for example, report five days before the due date for card company B whether the amount due can be debited on the due date.

Furthermore, the method for determining if the amount due can be debited from the registered account shall not be limited to the e-mail messages being sent automatically by the personal computer 45. For example, the user could manually enter the credit card number and billing month from a keyboard or other input device of the personal computer 45 to calculate the balance due on the specified credit card for the specified month, and then display or print the balance due using a printer 46. The user could then compare the balance due with the account balance to determine if sufficient funds are available.

Loading and Making Payments with Electronic Money

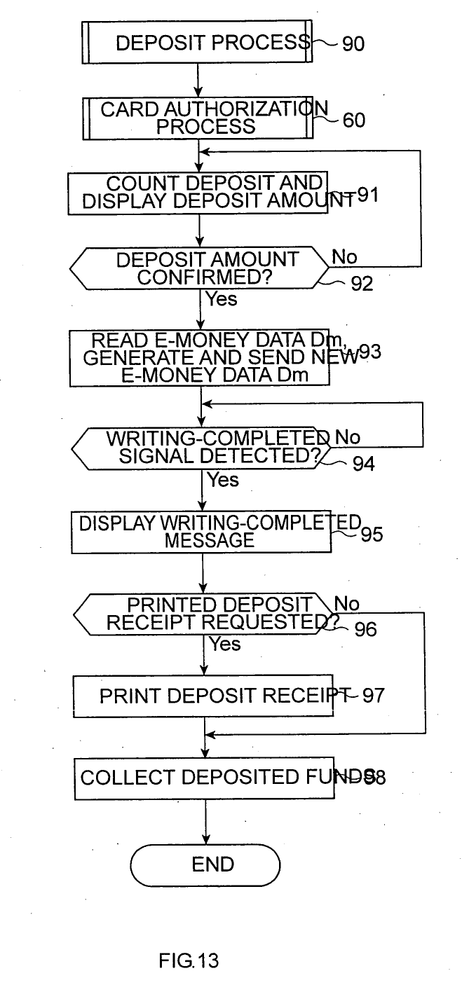

As noted above, this data processing system 1 also allows for cashless shopping using electronic money (prepaid funds) by prepaying in cash and writing e-money data Dm for the equivalent sum to the IC card 10. More specifically, before shopping the user loads electronic money in the IC card 10 using the user terminal 22 of a store's merchant terminal 2a. The deposit process 90 shown in FIG. 13 is run by the controller 39 of the user terminal 22 to load e-money into an IC card 10 as described below.

This deposit process 90 starts by running the card authorization process 60. If the card authorization process 60 ends without generating an error the controller 39 opens the cash deposit drawer, for example, drives the bill counter 35 to count the bills 18 inserted to the deposit drawer, and displays the resulting total on display 37 (step 91). If the number of bills 18 inserted to the deposit drawer and the total displayed on the display 37 do not match, the user presses a cancel button. If the totals match, however, the user presses a confirm button (step 92).

If the user confirms the deposit amount (step 92 returns yes), e-money data Dm is read from IC card 10. Based on the balance of the read e-money data Dm and the deposit amount calculated by the bill counter 35, the e-money data Dm is recalculated and sent to the IC card 10 (step 93). If this is the first time electronic money is being loaded into the IC card 10, e-money data Dm in IC card 10 has a balance of 0, and the recalculated e-money data Dm generated by controller 39 is therefore equal to the amount calculated by the bill counter 35.

The controller 39 then monitors whether a writing-completed signal was sent by the IC card 10 (step 94). If it was, a message is displayed on the display 37 telling the user that registering the e-money was completed successfully (step 95). The controller 39 then detects if the user requested a printed deposit receipt (step 96). If a print request is detected the controller 39 prints a receipt 19 (deposit receipt) from the printer 36 (step 97). When printing is completed, or if a printed receipt was not requested (step 96 returns no), the bills 18 are collected from the deposit drawer (step 98). Writing e-money data Dm to the IC card 10 (loading e-money) is thus completed.

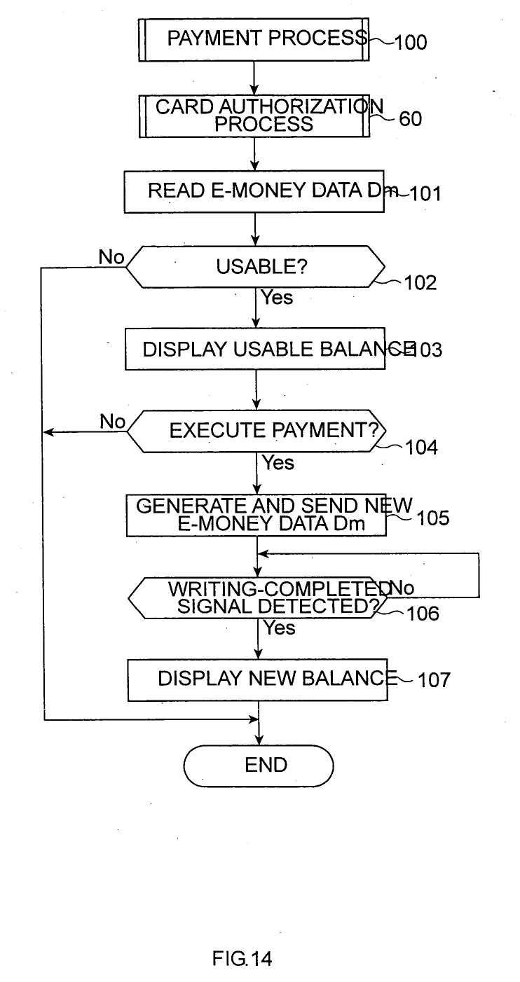

If the user then shops at merchant terminal 2b, for example, using an IC card 10 in which e-money has been loaded, the user hands the desired products to the clerk and brings the IC card 10 within communication range of the card reader/writer RW connected to the cash register 25. The cash register 25 then starts the payment process 100 shown in FIG. 14.

The payment process 100 starts with the card authorization process 60. If the card authorization process 60 ends without generating an error, the cash register 25 reads e-money data Dm from the IC card 10 using the card reader/writer RW (step 101). The cash register 25 then determines if e-money can be used based on the read e-money data Dm (i.e., whether the electronic money is usable and if the balance is sufficient) (step 102). If the usable balance is insufficient, the cash register 25 displays a corresponding message, ends the payment process 100, and proceeds with a cash purchase process. The payment process could also be configured to use the remaining e-money balance based on the e-money data Dm stored in IC card 10, generating e-money data Dm with a 0 balance and requiring the difference to be paid in cash, for example. If the e-money balance is sufficient for the purchase, however, the cash register 25 displays the usable e-money balance in the IC card 10 on a display (not shown in the figures) based on the e-money data Dm read from the card (step 103).

If the cash register 25 is instructed to complete payment using e-money (step 104 returns yes), new e-money data Dm reflecting the previous e-money balance minus the amount used is generated and sent to the card reader/writer RW (step 105). E-money data Dm storing the new e-money balance is thus written to the e-money data block B2 of data memory 13 in IC card 10.

The cash register 25 then monitors whether a writing-completed signal was sent from the IC card 10 (step 106). If a writing-completed signal is detected the new balance after processing payment is displayed (step 107) and the payment process 100 ends. The cash register 25 then starts the data writing process 50 described above to write receipt data Dr for the transaction just completed and paid for with e-money. The cash register 25 could in this case skip the card authorization process 60 in the data writing process 50 and proceed directly to generating and transmitting the receipt data Dr (steps 51, 52).

When a credit card is used to make a purchase, the POS terminal 21 or cash register 25 of a data processing system 1 according to the present invention generates and writes to an IC card 10 receipt data Dr containing three data fields, the amount paid, the credit card number used, and the payment method, for each transaction. Following the instructions of an accounting program P, personal computer 45 also runs a transaction management process including a sorting process (step 74 in the data retrieval process 70 described above) and a calculation process (step 84 in the payment information reporting process 80 described above). This sorting process groups usage history data Dh (transaction management data Dc2) generated from the receipt data Dr read from IC card 10 by credit card. The calculation process calculates payment totals for the usage history data Dh meeting specific conditions.

When a user shops using a credit card and IC card 10, the receipt data Dr is therefore written to the IC card 10, eliminating the need to keep and manage numerous paper credit card receipts. The total due on the credit card can also be calculated without using a hand calculator. Reconciling the credit card statement with credit card receipts is therefore much simpler and less burdensome for the user.

Furthermore, because receipt data Dr for multiple credit cards can be written to a single IC card 10 and transferred to and managed on a personal computer 45, reconciling credit card statements and account maintenance is made significantly easier when the user has multiple credit cards.

The POS terminal 21 or cash register 25 of the data processing system 1 described above also generate and write receipt data Dr to IC card 10 using card number information produced from the card number read from the credit card. Card number entry errors can therefore be prevented and credit card transactions can be processed more quickly compared with a store clerk manually entering the card number imprinted on the credit card to the POS terminal 21 or cash register 25. A more customer-friendly credit card transaction environment can therefore be provided.

Furthermore, when the credit card number and billing month are indicated with this data processing system 1, the personal computer 45 can determine the closing date for the indicated billing month based on the transaction management data Dc1 according to the instructions of an accounting program P, identify usage history data Dh for all credit card charges before the closing date and calculate the total of those charges as the payment due for the indicated billing month. The payment due can then be displayed or printed. Unlike conventionally reconciling a credit card statement using a manual calculator, the data processing system 1 of our invention makes it easier for the user to manage credit card usage and payments, and prevent credit card charges not being paid due to insufficient funds as a result of a reconciliation (calculation) error.

Furthermore, when a deadline set relative the settlement date (referred to as the “due date”) comes, the personal computer 45 of the data processing system 1 of our invention sends a message by e-mail, for example, informing the cardholder that the deadline has come, and can thus reliably inform the cardholder that the amount due will be debited from the settlement account on the settlement date. This data processing system 1 can help avoid a non-sufficient funds condition in which the amount due cannot be paid.

Yet further, by determining if the amount due can be debited from the settlement account on the due date based on the current balance of the settlement account and the amount due calculated by the personal computer 45, and reporting to the user via e-mail, for example, the user simply needs to present the IC card 10 when using a credit card and then retrieve the receipt data Dr written automatically to the IC card 10 to a personal computer 45, much of the work involved with managing and reconciling statements for the cardholder's credit cards is no longer necessary. The work involved with managing credit card use is thus made significantly easier.

Furthermore, because the POS terminal 21 and cash register 25 of a data processing system 1 according to preferred embodiments of the present invention contactlessly read and write receipt data Dr to the IC card 10 by means of a card reader/writer RW, receipt data Dr and other data can be written to and read from the IC card 10 by simply placing the IC card 10 on top of the card reader/writer RW, for example. Therefore, compared with reading/writing data by swiping a contact-type IC card across a contact head, for example, the data processing system 1 of our invention is easier for the operator of the POS terminal 21 and cash register 25 to use, and data read/write errors resulting from poor contact due to worn electrodes or contacts can be avoided.

Accounting and bookkeeping tasks are also made easier using receipt data Dr read from the IC card 10, and paper credit card receipts and cash receipts that make the user's wallet fat can also be eliminated, because the POS terminal 21 and cash register 25 of this data processing system 1 write receipt data Dr for paid purchases to the IC card 10. As also described above, personal computer 45 downloads from a web server 6 over a data communication network N2 balance data Db containing the remaining balance in the settlement account registered for paying each credit card. Compared with the user manually entering the account balance after updating the bank book, the method of the present invention reliably avoids balance entry errors and makes it easier to know the remaining account balance and whether the amount due can be debited from the appropriate account.

Yet further, the personal computer 45 and user terminal 22 of this data processing system 1 read the receipt data Dr written to the IC card 10 and then print or display the payee name, payment date, and amount paid according to the instructions of an accounting program P. It is therefore possible even when a paper receipt is not issued by the merchant for the personal computer 45 or user terminal 22 to print or display the content of the receipt data Dr so that the user can easily and reliably check for mistaken charges and payments, discounting errors, and other such mistakes.

The POS terminal 21 and cash register 25 also write receipt data Dr to the IC card 10 for purchases paid for by means other than a credit card, such as cash or electronic money. An accounting program P running on a personal computer 45 can therefore also track and manage such non-credit card expenses, and paper receipts for such transactions are therefore also not necessary. Compared with manually recording such purchases in an accounting ledger, such expenses can therefore be quickly and reliably entered into an accounting ledger by the personal computer 45.

Furthermore, by writing receipt data Dr to a card-type storage medium (IC card 10) used as the portable storage device in the accompanying claims of this invention, this data processing system 1 greatly reduces the burden on the user because a thin IC card 10 is highly portable compared with large-scale dedicated data storage devices.

When installed to a personal computer in the home, for example, an accounting program P according to another preferred embodiment of the invention can run a read process (step 71 in the data retrieval process 70) for reading multiple receipt data Dr records from the IC card 10 into the personal computer, and a transaction management process including a sorting process (step 74 in the data retrieval process 70 described above, that is, recording to transaction management data Dc2) and a calculation process (step 84 in the payment information reporting process 80 described above). This sorting process groups data relating to card number data, purchase date, and purchase amount in the receipt data Dr records read from the IC card 10 by credit card. The calculation process determines the total due for all purchases made with each credit card on the due date for the respective billing period. A general purpose personal computer can therefore be used as the second data processing device in a data processing system according to the present invention, and can run a transaction management process for managing credit card use.

By recording this accounting program P to an optical storage medium C or other recording medium, the accounting program P can be installed from the optical storage medium C to a personal computer that cannot be connected to the Internet or other network environment.

It will also be obvious that the present invention shall not be limited to the embodiments described above. For example, while the invention has been described using an IC card 10 as the card-type storage medium, removable storage devices shaped like a stick or brick, and electronic devices such as cell phones and personal digital assistants (PDA) with memory for storing receipt data Dr, for example, can be used as the portable storage device of the present invention.

The invention has also been described using a contactless IC card 10, but the portable storage device of this invention shall not be so limited. More specifically, a contact-type portable storage device having contacts for a physical connection can be used.

The invention has also been described as being able to write both receipt data Dr and e-money data Dm to the data memory 13 of the IC card 10, but the invention shall not be so limited. It is also possible, for example, to write only the receipt data Dr and not write e-money data Dm to the portable storage device.

Yet further, the IC card 10 itself could also be given the function of a credit card issued by a credit card company by, for example, assigning a credit card number to the IC card 10.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A data processing system for processing and storing information relating to purchases made with one or more credit cards comprising:
a portable storage device independent of the credit card used to make a credit card purchase, said storage device having a rewritable nonvolatile memory unit for storing credit card usage information;
a first data processing device for running a write process for generating card usage information for a payment made with a credit card when a credit card is used to make a purchase, and writing the credit card usage information to the portable storage device; and
a second data processing device comprising a processor for running a read process to read card usage information for each credit card written to the portable storage device.

2. A data processing system according to claim 1 further comprising means for enabling the portable storage device to communicate wirelessly with said first and/or second data processing portable storage device.

3. A data processing system according to claim 2, wherein the card usage information includes a payment amount and credit card number for the credit card used to make a purchase; and
wherein the processor of the second data processing device executes a transaction management process based on the card usage information read by the read process for grouping and sorting payment amounts by credit card number and for executing a calculation process for calculating totals for the sorted payment amounts.

4. A data processing system according to claim 3, wherein the card usage information further includes a payment deadline for the credit card used for purchases; and
the second data processing device further comprises an input unit for specifying a billing month for the credit card,
wherein the processor of the second data processing device includes means for calculating the total of payment amounts included within the payment deadline in the billing month specified using the input unit.

5. A data processing system according to claim 2, wherein the card usage information includes a payment amount and credit card number for the credit card used to make a purchase; and
the second data processing device further comprises a storage unit for storing an account number for a settlement account for the credit card used for purchases, and
wherein the processor of the second data processing device executes a transaction management process based on the card usage information read by the read process for grouping and sorting payment amounts by the account number and executes a calculation process for calculating totals for the sorted payment amounts.

6. A data processing system according to claim 5, wherein the card usage information includes a payment deadline for the credit card used for purchases; and
the second data processing device further comprises an input unit for specifying a billing month for the credit card,
the storage unit of the second data processing device further storing balance data for the settlement account, and
wherein the processor of the second data processing device includes means for calculating the total of payment amounts included within the payment deadline in the billing month specified using the input unit, comparing the total of payment amounts included within the payment deadline in the specified billing month with the account balance, and determining and reporting if the settlement amount due from the settlement account can be debited.

7. A data processing system according to claim 1, wherein the portable storage device includes means for contactlessly reading and writing the card usage information from said
first data processing device and said second data processing device respectively.

8. A data processing system according to claim 3, wherein the card usage information includes a product name for which payment was made or a store name to which payment was made, and
wherein the second data processing device includes means for printing or displaying the product name or store name and payment amount read from the portable storage device.

9. A data processing system according to claim 8, wherein the card usage information includes information relating to the payment method of the credit card used to make a purchase, and
wherein the second data processing device includes means for printing or displaying the payment method and payment amount read from the portable storage device.

10. A data processing method comprising the steps of:
providing a portable storage device having a rewritable nonvolatile memory unit for storing card usage information for one or more credit cards used to make a purchase, with the portable storage device being independent of the credit cards;
generating card usage information for a payment made with a credit card when a credit card is used to make a purchase;
writing the card usage information to the portable storage device;
reading the card usage information for each credit card written to the portable storage device; and
running a transaction management process based on the read card usage information.

11. A data processing method according to claim 10, wherein the card usage information includes a payment amount and credit card number for the credit card used to make a purchase; and
the transaction management process executes a sorting process for grouping payment amounts by credit card number and a calculation process for calculating totals for the sorted payment amounts.

12. A data processing method according to claim 11, wherein the card usage information further includes a payment deadline for the credit card used for purchases; and
the transaction management process calculates the total of payment amounts included within the payment deadline in a billing month specified by an operator.

13. A data processing method according to claim 10, wherein the card usage information includes a payment amount and credit card number for the credit card used to make a purchase,
the account number of a settlement account for the credit card used to make a purchase is pre-stored, and
the transaction management process executes a sorting process for grouping payment amounts by account number, and a calculation process for calculating totals for the sorted payment amounts.

14. A data processing method according to claim 13, wherein the card usage information further includes a payment deadline for the credit card used for purchases; and
the transaction management process calculates the total of payment amounts included within the payment deadline in the billing month specified by the operator,
receives the account balance of the settlement account for the credit card used for purchases,
compares the total of payment amounts included within the payment deadline in the specified billing month with the account balance, and
determines and reports if the settlement amount due from the settlement account can be debited.

15. A computer-readable recording medium for storing a computer program which implements a data processing method in a data processing device for reading and writing information to a portable storage device having a rewritable nonvolatile memory unit for storing credit card usage information for one or more credit cards used to make a purchase with said computer program including a read program to implement a read process for
reading card usage information from the portable storage device representative or purchases made by one or more credit cards; and
including a transaction management program for implementing the running of a transaction management process based on card usage information read by the read process.

16. A computer-readable recording medium according to claim 15 wherein the card usage information includes a payment amount and credit card number for the credit card used to make a purchase; and
wherein the transaction management process runs a sorting process for grouping payment amounts by credit card number and a calculation process for calculating totals for the sorted payment amounts.

17. A computer-readable recording medium according to claim 15 wherein the card usage information includes a payment amount and credit card number for the credit card used to make a purchase; and
wherein the transaction management process runs a sorting process for grouping payment amounts by the account numbers of the settlement accounts for the credit cards used for purchases, and a calculation process for calculating totals for the sorted payment amounts.
